(19) United States
(12) Patent Application Publication
(10) Pub. No.: US 2004/0119433 A1
(43) Pub. Date: Jun. 24, 2004

(54) Control device for opening/closing member

(75) Inventors: Tsutomu Tanoi, Kariya-shi (JP); Kenji Hori, Chiryu-shi (JP); Takashi Kikuta, Kariya-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA

(21) Appl. No.: 10/689,659

(22) Filed: Oct. 22, 2003

(30) Foreign Application Priority Data
Oct. 22, 2002 (JP) 2002-307564

(51) Int. Cl. H02P 3/00

(52) U.S. Cl. 318/469; 318/280

(57) ABSTRACT

A control device for an opening/closing member which changes a predetermined judgment value from a first judgment value to a second judgment value greater than the first judgment value after the operation of an operation switch is repeated for a predetermined time if the control for stopping and reversing the movement of the opening/closing member is repeated when the operation switch is operated to close the opening/closing member again after performing the control for stopping and reversing the opening/closing member, and the second judgment value is returned to the first judgment value after elapsing a predetermined time after changing the predetermined judgment value to the second judgment value.

This application is based on and claims priority under 35 U.S.C. § 119 with respect to Japanese Patent Application No. 2002-307564 filed on Oct. 22, 2003, the entire contents of which are incorporated herein by reference.

### FIELD OF THE INVENTION

The present invention relates to a control device for an opening/closing member. More particularly, the present invention pertains to a control device for an opening/closing member including a safety function for either reversing or stopping the movement of the opening/closing member by judging an entrapment of an object judged when the resistance greater than a predetermined level applies the opening/closing member during the closing operation of the opening/closing member.

### BACKGROUND OF THE INVENTION

With known control devices for an opening/closing member, a safety function is operated because of the increase of the resistance applied to the opening/closing member, for example, when a small external object such as the ice is attached to the opening/closing member. With the known control devices for the opening/closing member, in order to avoid a problem that the opening/closing member used, for example, for a window or a sunroof cannot be completely closed due to those small objects such as ice, the safety function is canceled when operating a switch for re-closing the opening/closing member after once the safety function is operated to completely close the opening/closing member. This functions based on the idea that the objects such as a hand are removed to avoid the entrapment when the opening/closing member is operated in the closing direction again after the operation of the safety function to reverse or stop the movement of the opening/closing member by detecting the entrapment during the closing process of the opening/closing member. In addition, in case the resistance is increased again at the re-closing operation, it is considered that the irremovable object such as the ice is attached. In both cases, the safety function is canceled with the known control devices. A Japanese Patent Laid-Open Publication No. H05-010067 describes the known control device.

Notwithstanding, the safety functions may accidentally operate when the actual entrapment of the objects is not observed, for example, when the large vibration is applied to a vehicle and when the electrical noise affecting the operation of the control device is generated. In this case, the movement of the opening/closing member may stop or reverse even if the object such as the hand is at a position to be entrapped without contacting the object such as the hand, then it is not preferable to cancel the safety function when the opening/closing member is re-operated in the closing direction. In addition, the recent safety function is required to operate with a smaller load. By operating the safety function with the further smaller load increase in order to increase the sensitivity of the safety function in accordance with this need, the frequency of the accidental operation of the safety function is increased.

A need exists for a control device for an opening/closing member, which always ensures the safety function even at the accidental operation of the safety function.

### SUMMARY OF THE INVENTION

In light of the foregoing, the present invention provides a control device for an opening/closing member which includes an opening/closing member movably provided at an opening portion for opening and closing the opening portion, an actuator for moving the opening/closing member, and an operational switch for commanding the operation of the actuator. The opening/closing member is controlled to stop or reverse the movement thereof when the resistance force affecting the opening/closing member is increased equal to or greater than a predetermined judgment value during a process for closing the opening portion by the opening/closing member. The predetermined judgment value is changed from a first judgment value to a second judgment value greater than the first judgment value after the operation of the operation switch is repeated for a predetermined time when the control for stopping and reversing the movement of the opening/closing member is repeated when the operation switch is operated to close the opening/closing member again after performing the control for stopping and reversing the opening/closing member. The second judgment value is returned to the first judgment value after elapsing a predetermined time after changing the predetermined judgment value to the second judgment value.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a perspective view of a sunroof device including a control device for an opening/closing member according to an embodiment of the present invention.

FIG. 2 is a magnified view of an actuator portion of FIG. 1.

FIG. 3 is an electric circuit of the actuator of the control device of the opening/closing member according to the embodiment of the present invention.

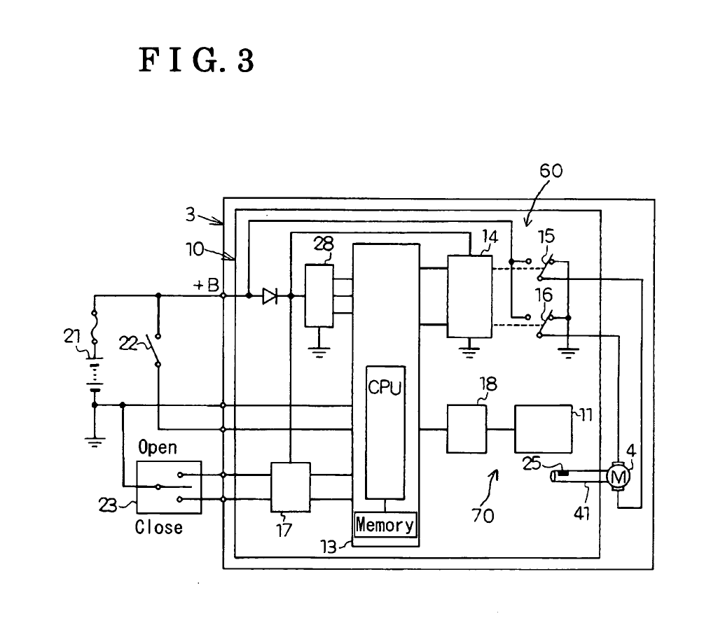

FIG. 4 is an operational flowchart of a safety device of the control device of the opening/closing member according to the embodiment of the present invention.

### DETAILED DESCRIPTION OF THE INVENTION

One embodiment of a control device of an opening/closing member applied to a sunroof device will be explained with reference to drawing figures as follows.

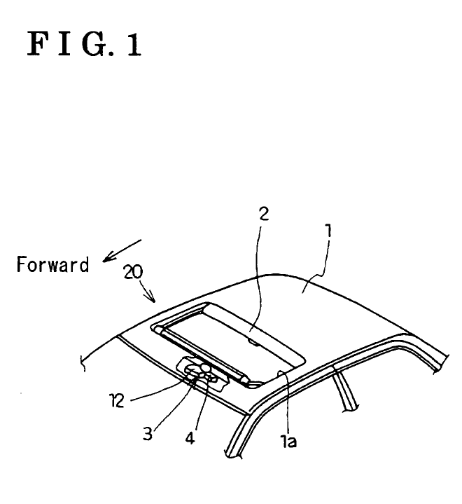

As shown in FIG. 1, a sunroof device 20 including a known construction and function includes a roof 1 and a slide panel (i.e., opening/closing member) 2 for opening and closing an opening portion 1a provided at the roof 1 by moving in a longitudinal direction (i.e., right, left direction of FIG. 1) of a vehicle.

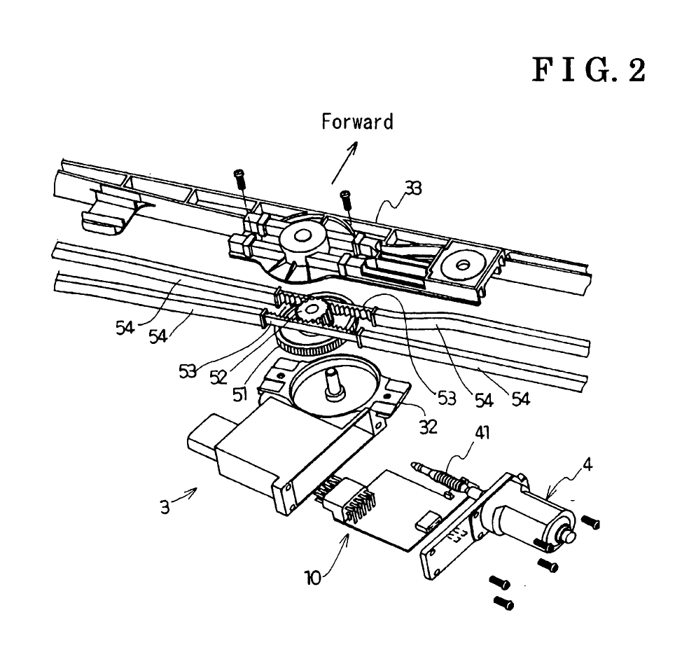

As shown in FIG. 2, the sunroof device 20 includes an actuator 3 provided in the roof 1 at a front side of the opening portion 1a. The actuator 3 includes a motor 4. The motor 4 includes a worm 41 serving as an output shaft. The worm 41 is engaged with a worm wheel 51 for reducing a rotation of the worm 41 to be transmitted. The worm wheel 51 includes a unitary formed pinion 52. The pinion 52 is sandwiched and geared with a pair of gear belts 53, 53. Two gear belts 53, 53 are linearly moved in opposite direction each other by the operation of the pinion 52. Each gear belt 53 is accommodated in and guided by a belt case 54 respectively. An attaching end portion of the belt case 54, the worm wheel 51, and the pinion 52 are provided in a bottom case 32 and a top case 33 to be fixed to the vehicle. Each gear belt 53 is guided by the belt case 54 along a rail (not shown) positioned at both sides of the opening portion 1a in the longitudinal direction for slidingly guiding the slide panel 2. An end portion of each gear belt 53 is connected to a known operational mechanism used for a sunroof, transmits the operation of the actuator 3 to the slide panel 2, and moves the slide panel 2 for closing and opening the opening portion by a normal rotation and reverse rotation of the motor 4.

An opening and closing control device 10 of the actuator 3 includes a circuit 60 including a relay drive circuit 14, relays 15, 16 for supplying the power to the motor 4 for actuating the motor 4 and a circuit 70 including an input interface 18 and a rotational sensor 11 for detecting a rotation of the motor 4. The rotational sensor 11 may correspond to a Hall IC for detecting the rotational number of the worm 41. A body 25 to be detected such as a magnetic body is attached to the worm 41 serving as the output shaft of the motor 4. The rotational sensor 11 includes the plural Hall IC. A plurality of output signals from the rotational sensor 11 are input into a microcomputer 13 including a predetermined control program via the input interface circuit 18 to calculate a moving direction and a position of the slide panel 2. The opening and closing control device 10 further includes, an interface circuit 17 and a power source circuit 28.

The relay drive circuit 14, each interface circuit 17, 18, and the power source circuit 28 are supplied with a predetermined electric voltage from a battery 21 of the vehicle. The signal when an ignition switch 22 is ON is input into the microcomputer 13. The opening and closing operation of the slide panel 2 is performed only when the ignition switch 22 is ON.

An operation switch 23 for operating the opening and closing operation of the slide panel 2 includes a construction to be ON at the opening and the closing of the slide panel 2. Both opening and the closing operations of the slide panel 2 are OFF when the operations witch 23 is at a neutral position. The signal for ON is input into the microcomputer 13 via the interface circuit 17. When the operation switch 23 is ON either for opening or closing, the motor 4 can be operated in the normal direction or the reverse direction by actuating the relays 15, 16 from the microcomputer 13 via the relay drive circuit 14. In other words, the opening and closing operation of the slide panel 2 is maintained by the command from the microcomputer 13 even if the operation switch 23 is not kept pushed (i.e., an automatic operation mode).

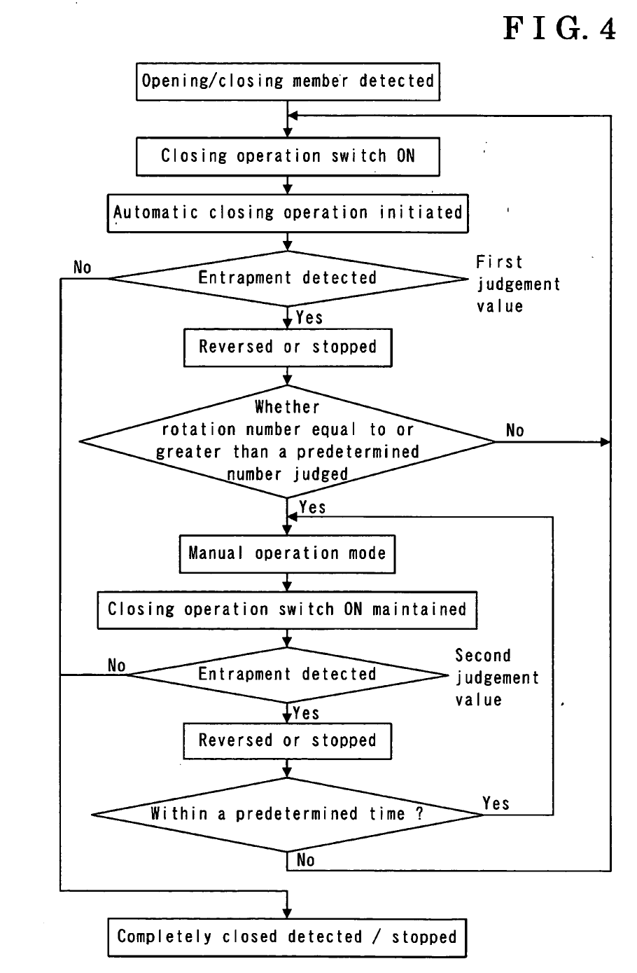

The microcomputer 13 of the opening and closing control device 10 includes a control program following a flowchart shown in FIG. 4. The control program includes a safety function program for preventing the entrapment by stopping or reversing the movement of the slide panel 2 if the object such as a hand is positioned at the opening portion 1a when the slide panel 2 is moved in the closing direction of the opening portion 1a by the control program.

The operation of the safety program for the sunroof device 20 will be explained as follows. The position and the moving direction of the slide panel 2 are detected by calculating the signal from the rotational sensor 11. When the operation switch 23 is operated to close the opening slide panel 2, an automatic closing operation of the slide panel 2 starts. In other words, the slide panel 2 keeps moving in the closing direction with a single operation of the operation switch 23 without keeping push thereof. If a hand is entrapped between the slide panel 2 and the opening portion 1a, the movement of the slide panel 2 is blocked to suddenly increase the resistance. In accordance with the increase of the resistance, the rotational number of the motor 4 is reduced, the rotational sensor 11 detects the change of the rotational number of the motor 4, and the increase amount of the resistance is calculated by the microcomputer 13. When the resistance equal to or greater than a predetermined threshold value (i.e., a first judgment value), which is not generated at the normal operation, is generated at a position of the slide panel 2 other than a completely closing the opening portion 1a.

However, the resistance exceeding the predetermined threshold value (the first judgment value) which is not generated at the normal operation may be detected when the entrapment is not actually observed, for example, when a small object such as the ice is applied to the slide panel 2, and at the accidental reasons such as when the large vibration is applied to the vehicle and when the electric noise affecting the control device is generated. In case the small object such as the ice is applied to the slide panel 2, the large resistance is detected when the slide panel 2 is moved to approximately the same position of the last operation until the small object such as the ice is removed. On the other hand, with the detection of the resistance at the accidental reason, the resistance is rarely detected at the same position of the slide panel 2 with the last operation again. With the control method according to the embodiment of the present invention, the automatic closing operation can be repeated by operating the operation switch 23 in the closing direction of the slide panel 2 for the plural times, for example, two or three times. If the resistance equal to or greater than the predetermined value is detected and the safety function is operated when the automatic closing operation is repeated plural times, it is judged that the resistance is not generated due to the object such as the trapped hand and it is not the accidental detection of the resistance due to, for example, the vibration and the noise. When it is judged that the resistance is due to the object such as the ice, the judgment of the entrapment by the first judgment value and the automatic closing operation mode is canceled. Thereafter, the slide panel 2 can be moved in the same direction only during the operation switch 23 is pushed (i.e., a manual mode). In this case, the threshold value is changed to be a second judgment value greater than the first judgment value so that the slide panel 2 can be completely closed even when the small object such as the ice is attached. Considering the cases such as the unintentional operation by the children, the second judgment value serves as the value for detecting the entrapment to avoid the accident. In the foregoing manner, the slide panel 2 attached with the small object such as the ice can be completely closed after opening in addition to completely ensuring the safety function. Because the judgment of the entrapment and the setting for canceling the automatic closing operation mode by the first judgment value is temporal, the automatic closing operation mode is recovered after an elapse of a predetermined time.

The opening and closing operation of the slide panel 2 is not explained because it is the same with the known sunroof device. The control device of the opening/closing member is not limited to the application to the sunroof and may be applied to a door for the vehicle, an opening and closing device for a window, or the like.

According to the embodiment of the present invention, because the control device for the opening/closing member is constructed to always ensure the safety function considering the accidental operation of the safety function, the safety function operating with small load and the secure safety function can be achieved.

The principles, preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A control device for an opening/closing member comprising:
an opening/closing member movably provided at an opening portion for opening and closing the opening portion;
an actuator for moving the opening/closing member;
an operational switch for commanding the operation of the actuator; wherein the opening/closing member is controlled to stop or reverse the movement thereof when the resistance force affecting the opening/closing member is increased equal to or greater than a predetermined judgment value during a process for closing the opening portion by the opening/closing member; wherein the predetermined judgment value is changed from a first judgment value to a second judgment value greater than the first judgment value after the operation of the operation switch is repeated for a predetermined time if the control for stopping and reversing the movement of the opening/closing member is repeated when the operation switch is operated to close the opening/closing member again after performing the control for stopping and reversing the opening/closing member, and the second judgment value is returned to the first judgment value after elapsing a predetermined time after changing the predetermined judgment value to the second judgment value.

2. The control device for the opening/closing member according to claim 1, wherein the opening/closing member is operated at an automatic operation mode for closing the opening/closing member with a single operation when operated by the first judgment value and the opening/closing member is operated at a manual mode for closing the opening/closing member by keep pushing the operation switch when operated at the second judgment value.
